(19) United States
(12) Patent Application Publication
(10) Pub. No.: US 2020/0371204 A1
(43) Pub. Date: Nov. 26, 2020

(54) MILLIMETER WAVE ARRAY

(71) Applicant: Tactual Labs Co., New York, NY (US)

(72) Inventor: Matthew James Connolly, Austin, TX (US)

(73) Assignee: Tactual Labs Co., New York, NY (US)

(21) Appl. No.: 16/879,698

(22) Filed: May 20, 2020

Related U.S. Application Data
(60) Provisional application No. 62/851,387, filed on May 22, 2019.

(51) Int. Cl. G01S 7/40; G01S 13/89; G06F 3/01

(52) U.S. Cl. CPC G01S 7/4008; G06F 3/017; G01S 13/89

(57) ABSTRACT

A sensor has a plurality of transmitting antennas and a plurality of receiving antennas. The plurality of transmitting antennas each transmit millimeter wave signals. An object or body part's interaction with and reflection of millimeter wave signals are determined by the signals received by the receiving antennas. Signals having different frequencies are used to provide resolution and positioning of an object or body part in the space proximate to and/or relative to the sensor. Interpretation of millimeter wave radio signals reflected by objects in the environment, by the sensor, can then be used to generate outputs to devices.

This application claims the benefit of U.S. Provisional Application No. 62/851,387 filed May 22, 2019, the contents of which are hereby incorporated herein by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The disclosed apparatus and method relate to the field of sensors, in particular the disclosed apparatus and method relate to radar sensors operating with millimeter wavelengths.

### BRIEF DESCRIPTION OF THE DRAWINGS

The foregoing and other objects, features, and advantages of the disclosure will be apparent from the following more particular description of embodiments as illustrated in the accompanying drawings in which reference characters refer to the same parts throughout the various views. The drawings are not necessarily to scale, emphasis instead being placed upon illustrating principles of the disclosed embodiments.

FIG. 1 shows an exemplary view of a sensor implementing an array of transmitting antennas and receiving antennas.

FIG. 2 is a flow chart of a method for providing different levels of resolution.

FIG. 3 is a diagram of an embodiment of a sensor.

FIG. 4 is a diagram of an embodiment of a sensor.

FIG. 5 is a diagram of a simple target tracking system that implements millimeter wave sensors.

FIG. 6 is a flow chart of the operation of the target system implementing the millimeter wave radar sensor system.

FIG. 7 shows scanning of an object with a millimeter sensor and image sensor.

FIG. 8 shows an example of a millimeter wave sensor array used to visualize an object in a poorly lit hallway.

### DETAILED DESCRIPTION

The presently disclosed systems and methods involve principles related to and for designing, manufacturing and using sensors implementing millimeter wavelength signals and signals located proximate to that sensing range. The disclosure discusses waves that operate at frequencies that are generally between 5 Ghz to 70 Ghz. These ranges generally fall within the radio frequency categories of super high frequency and extremely high frequency. The discussion and disclosure found within this application incorporate principles and concepts discussed in Applicant's corresponding application U.S. patent application Ser. No. 15/687,401, incorporated herein by reference.

The embodiments of millimeter-wave technology are designed in part for short-range interaction applications that may be implemented on wearables, mobile devices, or other devices with which a user interacts. In an embodiment, it is desirable that the systems and devices implementing the technology have the following qualities: high spatial resolution (in an embodiment, on the order of 1 mm of better); low latency (in an embodiment, less than 100 milliseconds, in an embodiment, less than 10 milliseconds, or better); low power usage; and small size (so that it can fit in small, portable devices, e.g., watches, mobile phones, wearables, etc.).

In an embodiment, wavelengths are used that fall within the millimeter wave frequencies and nearby spectrums. In an embodiment, a signal comprised of pulses is used. A signal comprised of pulses (narrow features) in the time domain tends to have excellent range resolution, but poor velocity (i.e. Doppler) resolution. In an embodiment, a signal comprised of narrow features in the frequency domain is used. A signal comprised of narrow features in the frequency domain (e.g. sinusoids) tends to have excellent velocity resolution, but poor range resolution. In an embodiment, a noise-like signal is used. A noise-like signal can have range resolution and velocity resolution that are both excellent.

Range precision (i.e., minimum measurable difference in target range) of a signal deployed in an embodiment of the present invention is proportional to the propagation velocity of the signal and inversely proportional to the signal's bandwidth (BW) and to the square root of its signal-to-noise ratio (SNR). The following formula describes that relationship.

r_{prec}≈vₚ/BW\sqrt{SNR} (1)

It will be apparent to one of skill in the art in view of this disclosure that the higher the bandwidth and SNR, and the lower the propagation velocity, the more precisely range is measured.

It has also been discovered that the velocity precision (i.e. minimum measurable difference in target velocity) of a signal deployed in an embodiment of the present invention is proportional to the propagation velocity of the signal and inversely proportional to the signal's duration and to the square root of its signal-to-noise ratio. The following formula describes that relationship.

v_{prec}≈vₚ/T\sqrt{SNR} (2)

In both cases above, the signal-to-noise ratio corresponds to power: it is the ratio of the signal power to the noise power.

In an embodiment, precision in both measured range and measured range rate are increased to the extent possible for a given implementation. As used above, precision means having a smaller measurable difference; and measured range rate refers to velocity in the range direction. In an embodiment, precision is achieved by decreasing r_{prec} and v_{prec}. In an embodiment, precision can be achieved by decreasing vₚ, however the propagation velocity is almost always fixed for a particular technology (vₚ=c for RF). In an embodiment, increasing the SNR will help in both cases, but the benefit only increases with the square root of the amount of power put in and, in many applications, power is limited. In an embodiment, a waveform that is both broadband and has a long time duration allows simultaneous measurement of both the range and range rate (velocity) with good precision. In an embodiment, a noise-like waveform with sufficient bandwidth, transmitted (and received) over a sufficient time period will yield the required precision.

By way of example, in an embodiment, to achieve a spatial precision on the order of one millimeter without going to a high SNR, the bandwidth is on the order of 300 GHz for radio waves traveling at c. In an embodiment, the center frequency is at least half of the bandwidth. The specific numbers presented for this embodiment are estimates, and are affected by other factors, such as the SNR and the geometry of the transmitter and receiver. In an embodiment, a monostatic geometry is employed, with waves traveling out to a target and the reflection traveling back the same way, the range is essentially doubled so that only half the bandwidth is required.

In some embodiments (including where received noise is independent from the signal, additive, white and Gaussian) a matched filter may be employed. In an embodiment, a matched filter may be optimal or may be the most practical method for recovering the received signal.

Due to the velocity of propagation of the signal and the distance to the target the delay between transmission of a signal and its reception may be measured. In an embodiment, the delay between transmission of a signal and its reception is measured accurately. In an embodiment, the delay between transmission of a signal and its reception is measured as accurately as possible. The Doppler shift of the signal is a metric to measure the relative velocity of the target, i.e. the velocity of the object in the direction of the phase center of the emitter and receiver. Thus, in an embodiment, the Doppler shift of the signal is measured accurately. In an embodiment, the Doppler shift of the signal is measured as accurately as possible. In an embodiment, both the delay and Doppler shift are measured by calculating the cross-ambiguity function (CAF). In an embodiment, the CAF produces a two-dimensional output for each transmitter/receiver pair, the output showing the response of the matched filter for each possible Doppler shift and each possible time shift (delay) that the signal experiences in traveling from the transmitter to the receiver, via any targets. The Doppler shift and time shift corresponding to the relative velocities and positions of any targets in the field of view of the transmitter and receiver, and provides information about the relative position and velocity of the transmitter to the receiver (if these are in each other's fields of view).

The preceding sets forth general properties and characteristics of millimeter range radar waves. The following disclosure provides implementations and usages that take advantage of the properties of the millimeter range waves.

The sensors discussed herein use transmitting and receiving antennas (also referred to herein as conductors). However, it should be understood that whether the transmitting antennas or receiving antennas are functioning as a transmitting antenna, a receiving antenna, or both depends on context and the embodiment. In an embodiment, the transmitting antennas and receiving antennas for all or any combination of patterns are operatively connected to a single integrated circuit capable of generating and processing the required signals. In an embodiment, the transmitting antennas and receiving antennas are each operatively connected to a different integrated circuit capable of generating and processing the required signals, respectively. In an embodiment, the transmitting antennas and receiving antennas for all or any combination of the patterns may be operatively connected to a group of integrated circuits, each capable of generating and processing the required signals, and together sharing information necessary to multiple IC configurations. In an embodiment, where the capacity of the integrated circuit (i.e., the number of transmit and receive channels) and the requirements of the patterns (i.e., the number of transmit and receive channels) permit, all of the transmitting antennas and receiving antennas for all of the multiple patterns used by a controller are operated by a common integrated circuit, or by a group of integrated circuits that have communications therebetween. In an embodiment, where the number of transmit or receive channels requires the use of multiple integrated circuits, the information from each circuit is combined in a separate system.

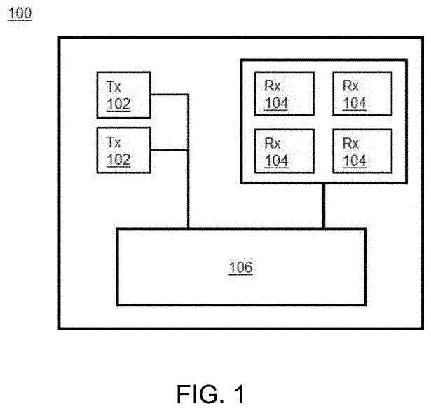

FIG. 1 sets forth an exemplary view of a sensor 100 implementing an array of transmitting antennas 102 and receiving antennas 104. The transmitting antennas and receiving antennas are operably connected to a controller 106, controller 106 comprises a signal processor and signal generator and its associated circuitry. In the embodiment shown there are two transmitting antennas 102 and four receiving antennas 104. In an embodiment, there are a plurality of transmitting antennas and one receiving antenna. In an embodiment, there are a plurality of receiving antennas and one transmitting antenna. In an embodiment, the transmitting antennas and the receiving antennas switch roles during different time frames, e.g., the transmitting antenna transmits a signal during the first time frame and during a second time frame the transmitting antenna functions as a receiving antenna.

Still referring to the sensor 100 shown in FIG. 1, in operation the transmitting antennas 102 transmit a signal that can be represented by a predefined pattern of a plurality of bits. The transmitted signals are formed as sine waves when transmitted. The signals transmitted by the transmitting antennas 102 are pulsed so that there is a time frame when the signal is transmitted and a time frame when the signal is not transmitted. As mentioned, the signal that is transmitted from the transmitting antennas 102 is modulated to a pattern represented by a predefined pattern of a plurality of bits. The plurality of bits permits the signal to be distinguished from other signals that are transmitted at the same time and that operate in the same frequency spectrum. The larger the number of bits contained in a signal the more that noise can be minimized in the system. The sensor 100 has a comparator that permits signals that are received to be compared to ensure that signals do not interfere with each other. When more than one device is used, pseudorandom sinusoidals and a comparator can be implemented in order to distinguish between two devices.

Still referring to FIG. 1, when the transmitting antenna 102 transmits a signal a user may place a body part or object in a position so that the signal interacts with the body part or object. In an embodiment, interacting with the signal comprises reflecting the signal. The interaction of the signal with the body part or object may permit the controller 100 to take signals that are received by one of the receiving antennas 104 and process the signals. In an embodiment, the received signals are processed and represented in quadrature format (I and Q format). The processed signals are processed and used so that the movement expressed by the body part or object is able to be distinguished. In an embodiment, the movement distinguished is used to implement a command, and/or generate an event/interrupt or other function that is expressed in the operation of the system to which the sensor is operably connected. In an embodiment, the movement distinguished is used to determine the position of a body part or object. In an embodiment, the movement distinguished is used to determine activity in a region.

Various types of movements and poses can be distinguished by the sensor 100. The sensor 100 is able to determine velocities of motions similar to those used when pushing, pressing or sliding. In an embodiment, the distinguished movement is a determined velocity related to a pushing motion. In an embodiment, the distinguished movement is a determined velocity related to a turning motion. In an embodiment, the distinguished movement is a sliding motion. In an embodiment, the distinguished movement is a determined velocity related to a typing motion. In an embodiment, the distinguished movement is a determined velocity related to a pulling motion. In an embodiment, the distinguished movement is a determined velocity related to a twisting motion. In an embodiment, the distinguished movement is a determined velocity related to a tapping motion. In an embodiment, the distinguished movement is a gesture that provides a command to a system or device.

In an embodiment, the distinguished movement is used to operate a wearable. In an embodiment, the distinguished movement is used to operate a vehicle control. In an embodiment, the distinguished movement is used to operate a household item. In an embodiment, the distinguished movement is used to operate a mobile device. In an embodiment, the distinguished movement is used to operate a computer. In an embodiment, the distinguished movement is used to operate a keyboard. In an embodiment, the distinguished movement is used to operate a toy. In an embodiment, the distinguished movement is used to operate a keypad for a lock. In an embodiment, the distinguished movement is used to select items at a kiosk.

In an embodiment, each of the transmitting antennas 102 transmits a separate signal. The signals transmitted may extend to different distances with respect to the sensor 100 and the location of the transmitting antennas 102. In this way different transmitting antennas 102 can provide a way in which different resolutions with respect to the object or body part that is interacting with the transmitted signal can be made. For example, one transmitted signal may provide better resolution out to a distance of 5 meters, while another transmitted signal may provide better resolution out to a distance of 3 meters. In an embodiment a gross scan can be performed to ascertain movement before switching to another signal to provide finer resolution. In an embodiment, the signals providing separate resolution may be transmitted from the same transmitting antenna 102, however during different time frames. In an embodiment, each of the transmitting antennas 102 transmit a plurality of signals, each of the signals providing a different resolution than the other signal. In an embodiment, a plurality of transmitting antennas may each provide different signals, wherein each of the transmitted signals provide a different resolution. In an embodiment, a plurality of transmitting antennas may each provide signals, wherein each of the transmitted signals transmitted by the transmitting antennas 102 is followed by a transmitted signal having the same frequency but a different phase.

In an embodiment, the transmitted signal is varied to provide resolution based on the predicted movement of the body part. For example, an approaching finger may be visualized by the sensor 100 and the signal transmitted by the transmitting antennas 102 changed to a signal providing better resolution at a closer distance as it approaches based upon the anticipated approach of the finger. In an embodiment, the sensor 100 includes a plurality of transmitting antennas 102 where each transmits a plurality of signals that provide different resolutions. Each of the plurality of the transmitted signals is received by receiving antennas and used to determine the movement of the object or body part that enters within the range of the transmitted signals. Movement of the object or body part within the field of the signals transmitted is used to predict future movement of the object or body part and predictively adapt the signal that is transmitted so as to provide better resolution at various distances from the sensor 100.

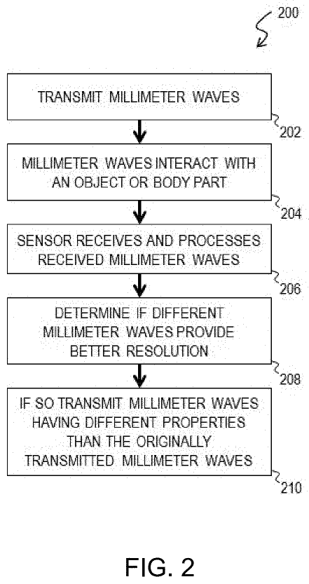

Turning to FIG. 2, shown is a flow chart illustrating a process for providing improved resolution of an object (or body part). In step 202, millimeter wave signals are transmitted from at least one transmitting antenna. The millimeter wave signals have a range that extends to some distance from the sensor. By range, it is meant a distance in which signals received by the sensor are able to be interpreted so that meaningful information may be received. In an embodiment, the millimeter wave signals used have ranges that extend from 10 mm to 15 m. In an embodiment, the millimeter wave signals used have ranges that extend from 1 mm to 20 m. In an embodiment, the transmitted millimeter wave signals may sweep a space proximate to the sensor. In an embodiment, the transmitted millimeter wave signals are directed to predetermined locations. In an embodiment, the transmitted millimeter wave signals are directed in a single direction.

In step 204, the transmitted millimeter wave signals interact with (e.g. reflect off of) an object or body part. When the signals interact with an object or body part some of the signals are directed back towards the sensor and received by the sensor.

In step 206, the sensor receives and processes the received signals. From the received signals, information regarding the location and movement of the object or body part is determined based on measurements of received signals.

In step 208, the information is used to determine if better resolution (i.e. an improved ability to distinguish and determine movements of objects within the signal space) can be obtained by transmitting different millimeter wave signals (e.g., having different physical and electromagnetic properties). For example, from the processed signals, a determination can be made that switching from a millimeter wave signal that has resolution at a longer range to a millimeter wave signal that has a resolution at a shorter range would provide improved resolution.

In step 210, the transmitting antenna transmits millimeter wave signals having different properties than the millimeter wave signals transmitted in step 202. The different properties of the millimeter wave signals transmitted in step 210 provides better resolution of the object or body part that is interacting with the signals. In an embodiment, the same transmitting antenna may transmit a millimeter wave signal with a different range (i.e. a different millimeter wave signal having a different wavelength and frequency). In an embodiment, a different transmitting antenna may transmit a millimeter wave signal from the transmitting antenna that transmitted the millimeter wave signals being used for determining range. In an embodiment, more than one transmitting antenna may each transmit different millimeter wave signals in order to provide different levels of resolution. In an embodiment, the transmitted signal has a different phase. In an embodiment, the transmitted signal implements a different modulation scheme.

When using an array of transmitting antennas, beamforming of the signals transmitted can be performed by transmitting the same signal from more than one of the transmitting antennas. In an embodiment, each of the signals transmitted may be offset from each other in phase. The use of the plurality of signals helps shape the signal in a particular direction. Each additional transmitting antenna can assist in shaping and boosting the signal. Arrays of transmitting antennas can be arranged in specific configurations. Additionally, phase manipulation of the signals propagated through the transmitting antennas can be used to provide directional signal transmission through constructive and destructive interference. These techniques can be used with the transmitting antennas and receiving antennas in order to achieve spatial selectivity and scan a particular region relative to the sensor array for signals that have interacted with a body part or object (e.g. reflected signals).

The phase shift between two successive elements (e.g. transmitting antennas) of the sensor array is constant and is called phase-incremental. In order to achieve beam steering to a particular angular value offset from the main transmission pattern, the following equation is used:

Δφ=360°·d·sin θₛ/λ (3)

Δφ is the angular resolution, λ is the wavelength, d is the distance between radiating elements, θₛ is the phase difference between radiating elements.

Beamforming angular resolution is a product of the number of and spatial location of a series of transmitting and receiving antennas. By way of example, in an embodiment where the transmitting antennas are 2 mm apart and operating at a frequency of 60 GHz (5 mm wavelength), beam steering with angular resolutions ±14°, ±29°, ±36° and ±50° from the main transmitting vector, perpendicular from the sensor array is able to be achieved. One sensor array can scan across a single axis. Using multiple sensor arrays scanning can be achieved in three directions.

In an embodiment, the plurality of transmitting antennas are used to create beamforming. In an embodiment, the plurality of receiving antennas are used to create beamforming. In an embodiment, three transmitting antennas are used to create beamforming. In an embodiment, four transmitting antennas are used for beamforming. In an embodiment, three receiving antennas are used for beamforming. In an embodiment, four receiving antennas are used for beamforming. In an embodiment, a combination of transmitting antennas and receiving antennas switching their respective functions are used for beamforming. In an embodiment, a combination of transmitting antennas and receiving antennas are used for beamforming.

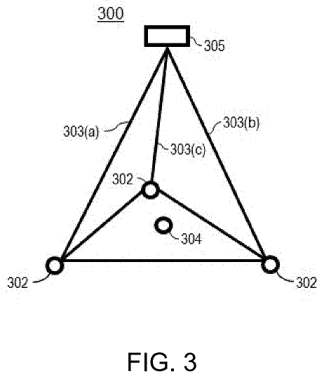

Turning to FIG. 3, shown is an embodiment of a sensor 300 having an arrangement of transmitting antennas 302 and a receiving antenna 304. The transmitting antennas are arranged in a triangular pattern. Signals 303(a)-(c) are transmitted from the transmitting antennas 302 and interact with an object 305 that is located within the space proximate to the transmitting antennas 302. As the object interacts with the transmitted signals 303(a)-(c), the transmitted signals 303(a)-(c) received at the receiving antenna 304 are processed to determine the interaction the object 305 had with the signals 303(a)-(c). As the object moves throughout the space, the position of the object 305 with respect to each of the transmitting antennas 302 is shown. As may be noted by those skilled in the art, the number of transmitting antennas and receiving antennas is non-limiting.

In an embodiment, the roles of the transmitting antennas 302 and the receiving antenna 304 are reversed so that there is one transmitting antenna that is transmitting a signal and multiple receiving antennas that receive the signals. In an embodiment, the one transmitting antenna transmits multiple signals that are different from each other. Each of the signals received is used to distinguish the position and movement of an object or body part interacting with the signals. In an embodiment, the arrangement of transmitting antennas 302 and the receiving antenna 304 are used to provide beamforming techniques so as to focus the transmission of the millimeter wave signals.

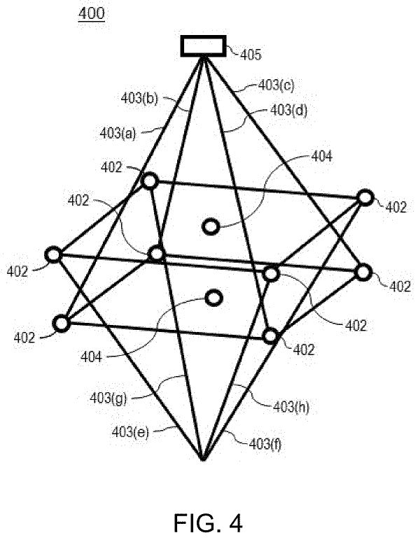

Turning to FIG. 4, shown is an embodiment of a sensor 400 having an arrangement of transmitting antennas 402 and receiving antennas 404. The transmitting antennas and receiving antennas 404 are arranged as two squares spaced apart. Signals 403(a)-(g) are transmitted from the transmitting antennas 402 and interact with an object 405 that is located within the space proximate to the transmitting antennas 402. As the object interacts with the transmitted signals 403(a)-(g), the transmitted signals 403(a)-(g) received at the receiving antennas 404 are processed to determine the interaction the object 405 had with the signals 403(a)-(g). As the object moves throughout the space, the position of the object 405 with respect to each of the transmitting antennas 402 is shown.

In an embodiment, the roles of the transmitting antennas 402 and the receiving antennas 404 are reversed so that there is one or two transmitting antennas that are transmitting signals and multiple receiving antennas that receive the signals. In an embodiment, the one or two transmitting antennas transmit multiple signals that are different from each other. Each of the signals received is used to distinguish the position and movement of an object or body part interacting with the signals. Using squares spaced apart can permit sensing signals in two different directions that permit determining information about the object or body part interacting with the signals.

The sensors and the arrangement of antennas forming the sensors may be formed having different geometries in addition to the square and triangle shapes discussed above. In an embodiment, the sensors and the arrangement of antennas forming the sensors are arranged as rectangles. In an embodiment, the sensors and the arrangement of antennas forming the sensors are arranged as polygons approaching a circular shape. In an embodiment, the sensors and the arrangement of antennas forming the sensors are arranged as pentagons. In an embodiment, the sensors and the arrangement of antennas forming the sensors are arranged as hexagons. In an embodiment, the sensors and the arrangement of antennas forming the sensors are arranged as heptagons. In an embodiment, the sensors and the arrangement of antennas forming the sensors are arranged as octagons. In an embodiment, the sensors and the arrangement of antennas forming the sensors are arranged as polygons. In addition to two dimensional geometries, in embodiments the sensors and the arrangement of antennas forming the sensors are arranged as pyramids, cubes, tetrahedrons, dodecahedrons, icosahedrons, etc.

In an embodiment, sensors can be arranged in different geometric patterns and arrangements in order to determine information regarding the interaction of an object or body part with signals. In an embodiment, the sensors are arranged in an array of sensors where each of the sensors has a plurality of transmitting antennas and/or receiving antennas. In an embodiment, the sensors are arranged in a matrix array. In an embodiment, the sensors are arranged in a random array. In an embodiment, the sensors are arranged to cover the surface of an object. In an embodiment, the sensors are arranged in a dispersed array.

In an embodiment, the signals transmitted have information embedded in the signals. By having information embedded in the signals various signals can be used to provide information. The embedded information can contain identification information and positional information. In an embodiment, sensors can use the information contained within the signals in order to correlate and correspond information with respect to each other. For example, two transmitting antennas can each transmit a signal having some identifying information as well as additional information regarding previously interpreted signals and the positions indicated by the signals. One hand having a sensor transmits a first signal, a second hand having a sensor transmits a second signal. A receiving antenna located on the sensor on the first hand receives the first signal, but also a second signal from the second hand with the additional information. This information is then able to be used to provide contextual information regarding the position of the second hand with respect to the first hand.

The millimeter wave sensors discussed above can be implemented in various systems and used in different applications. One application in which the millimeter wave sensors may be used are within automobiles. In an embodiment, the millimeter wave sensors are used to map the interior of vehicle spaces. In an embodiment, the millimeter wave sensors are used to identify passengers. In an embodiment, the millimeter wave sensors are placed at locations for controlling interior features of the vehicle, to activate volume, control mirrors, control seat position, change radio or music stations, lock/unlock doors, and/or move windows up and down.

Another application for which millimeter wave sensors can be used is in the implementations of augmented reality (AR) and virtual reality (VR) gesture applications. Information received from transmitting and receiving millimeter waves can be used to distinguish movement of body parts within the signal space. The information can be used to differentiate different gestures when a hand, for example, is within a specific range of the millimeter wave sensor. This is due to the high resolutions that are possible with the millimeter wave sensors and the improved sampling frequencies. Gestures, positioning of hands, user discrimination can be determined using the millimeter wave sensors discussed above. Implementation of the resolution and beamforming techniques using the millimeter sensor arrays can provide focused and multi-layered determination of the movement of hands.

Another application for the millimeter sensor arrays are for exteroceptive sensing for autonomous systems in low light to no light environments. Exteroceptive sensors permit robotic systems to map environments using simultaneous localization and mapping (SLAM). Implementation of the beam steering capability of the millimeter wave sensor permits enhancement of robotic mapping systems. The millimeter wave sensors can be used to map the interior of rooms and various environments with enhanced resolution. The mapping of the interior of rooms with fine resolution can provide robots implementing autonomous steering capabilities to navigate with increased precision. In an embodiment, millimeter wave sensors are used to provide mapping to vacuum robots. In an embodiment, millimeter wave sensors are used to provide mapping for automobiles. In an embodiment, millimeter wave sensors are used to provide mapping to factory robots. In an embodiment, millimeter wave sensors are used to provide mapping to industrial robots used for mining or other activities.

Another implementation of the millimeter wave sensors is in use with unmanned aerial vehicles (UAV). A major roadblock towards full UAV deployment in urban and mountainous areas is their inability to negotiate obstacles and avoid collision with other aircraft while flying at or near cruise speed. There is a need for UAV obstacle and collision detection and avoidance systems that do not impede the speed of the UAV significantly while mapping the environment and making decisions as to what is the safest route around obstacles and other aircraft. By leveraging the range and response rate provided by millimeter wave radar, for example 15 meters, with its low mass, minimum footprint and beamforming ability, the millimeter wave sensors are implemented in the obstacle avoidance radar systems.

The millimeter wave sensor is also able to be implemented into sports and gaming systems. A millimeter wave sensor can be equipped on targets. The millimeter wave sensor can determine when objects strike the target and from where the objects come from. The high speed capability of the millimeter wave sensor can provide real time feedback on the accuracy with respect to the target.

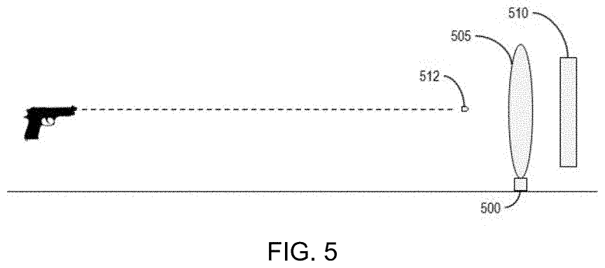

Referring to FIG. 5 shown is a simple diagram of a target tracking system that implements the millimeter wave sensors. The system comprises the millimeter wave sensor 500 that is located in front of the target 510. Field 505 represents the sensing area of the millimeter wave sensor 500. Projectile 512 heads to the target 510 and passes through the field 505. When the projectile 512 passes through the field it is detected by the millimeter wave sensor 500.

The millimeter wave sensor 500 can determine the number of projectiles. In an embodiment, the millimeter wave sensor 500 can determine when the projectile 512 strikes the target 510. In an embodiment the millimeter wave sensor detects a signature of the projectile that is consistent between projectile categories and the projectile's velocity spectrum (subsonic to supersonic). The low cost of the millimeter wave sensor, in addition to its reduced footprint, enhanced resolution (in comparison to traditional radar technologies) and ease of integration into small, mass produced embedded devices makes this arrangement desirable. In an embodiment, implementing additional sensors and time multiplexed triggering, enhanced levels of accuracy and robustness in response are achieved. Due to the low packet size for data, and the availability of onboard memory with the millimeter wave sensor to facilitate firmware deployment, data transmissions can be kept to a minimum size, sending only events and spatial coordinates to a host application for visualization and feedback systems. In an embodiment, in addition to projectile counting and target strike detection, analysis of radar cross sections indicates trajectories of projectiles to indicate the source direction of incoming projectiles. Analysis of radar cross sections could also be used to interpret projectile size. Time domain analysis may also be used to provide trajectory estimation.

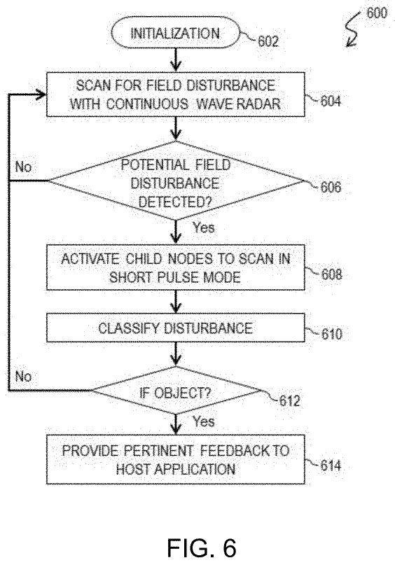

Referring to FIG. 6, where a flow chart of the operation of the target system is shown, an embodiment of the target system would initially utilize a single pair of transmitting antennas and receiving antennas from the millimeter wave sensor. In step 602, the system is initialized. In step 604, the millimeter wave sensor runs in a continuous wave configuration and scans for field disturbances with the continuous wave radar. In step 606, if a field disturbance is recognized, the system continues to step 608; if not, the system returns to step 604. In step 608, the interrupt event then triggers the activation of other parallel millimeter wave sensors (or RF extensions) to capture radar responses using a chirp pattern that is suited for modeling the projectile passing through the field. In step 610, the disturbance is classified and provides details to determine trajectory, velocity, caliber and other data from multiple vantage points in order to create a comprehensive model of the projectile. Then, in step 612, if an object is detected, the spatial data obtained in step 610 can then be offloaded to a host processor for classification, visualization, generating interrupts, events or other features that are related to the spatial data, accomplished in step 614. If no object is detected in step 612, the system returns to step 604.

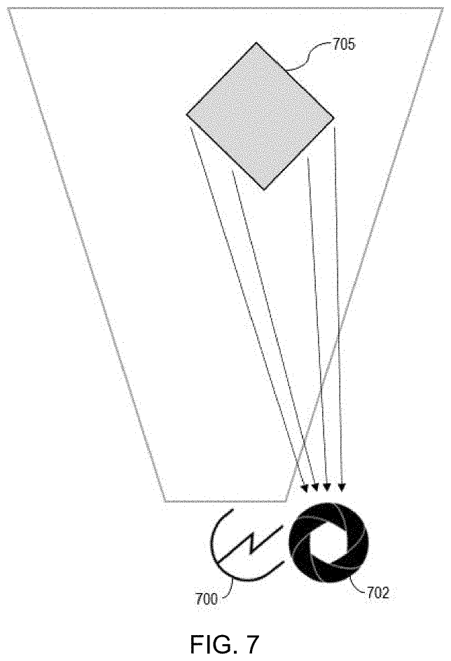

Another implementation of the millimeter wave sensor is for 3D measuring, imaging and realization through, for example, colocation of radar to a photoreceptor. Referring to FIG. 7, an object 705 may be scanned with millimeter wave sensor 700 in conjunction with the object 705 being scanned by an image sensor 702. By having a millimeter wave sensor 700 scan the object 705 along with an image sensor 702 the object 705 can be further discriminated in order to enhance the imaging. For example, an object 705 in a low light situation can be visualized where previously it could not.

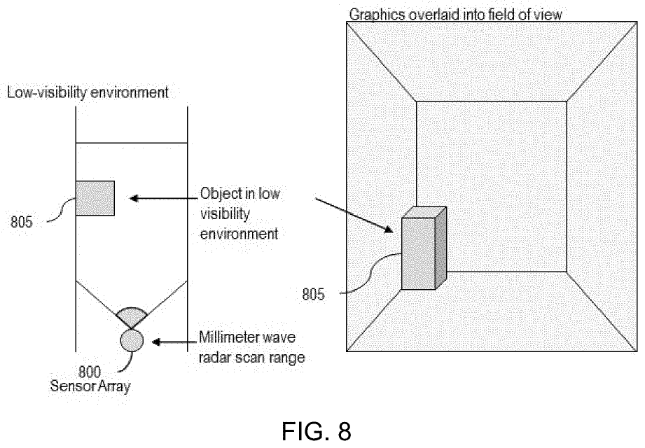

FIG. 8 shows an example of a millimeter wave sensor array 800 being used to visualize an object 805 in a poorly lit hallway. The millimeter wave sensor array 800 can operate in environments with little to no ambient light sources, such as, for example, thick forests and indoors. The millimeter wave sensor array 800 can also operate in conditions with limited visibility due to dust and/or other atmospheric particulates, such as in fire situations where there is smoke. In an embodiment, the millimeter wave sensor array is incorporated into goggles worn at night or in other poor visibility environments. In an embodiment, the millimeter wave sensor array is combined with non-millimeter range radar, infrared, and thermal sensors to generate an enhanced view of the surrounding environment to the end user to generate supplementary ranging capabilities. In an embodiment, the millimeter wave sensor array is collocated at eye level upon a headset or an existing night optics device. In an embodiment, the data from the millimeter wave sensor array is then processed and overlaid into raw night vision or image feeds, creating depth of field, velocity, and dynamic vs static environment object data by comparing velocities of objects in the field of view to the user's motion data.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time, after the second time or simultaneously with the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristics. Thus, for example, a first and a second frequency, absent further limitation, could be the same frequency, e.g., the first frequency being 10 Mhz and the second frequency being 10 Mhz; or could be different frequencies, e.g., the first frequency being 10 Mhz and the second frequency being 11 Mhz. Context may dictate otherwise, for example, where a first and a second frequency are further limited to being frequency orthogonal to each other, in which case, they could not be the same frequency.

An aspect of the present disclosure is a millimeter wave sensor array. The millimeter sensor array comprises a signal generator adapted to generate a plurality of millimeter wave signals; at least one transmitting antenna operably connected to the signal generator and adapted to transmit at least one millimeter wave signal from the plurality of millimeter wave signals; at least one receiving antenna adapted to receive millimeter wave signals; and a signal processor adapted to process received millimeter wave signals, wherein when a processed millimeter wave signal indicates an object or body part has interacted with the at least one millimeter wave signal, another millimeter wave signal is transmitted that is different than the at least one millimeter wave signal, wherein the another millimeter wave signal is adapted to provide better resolution of the object or body part than the at least one millimeter wave signal when processed.

Another aspect of the present disclosure is a method of improving resolution of a millimeter wave sensor array. The method comprises generating a plurality of millimeter wave signals with a signal generator; transmitting the plurality of millimeter wave signals from at least one of a plurality of transmitting antennas operably connected to the signal generator; receiving at least one millimeter wave signal from the plurality of millimeter wave signals at at least one receiving antenna operably connected to a signal processor and adapted to receive the plurality of millimeter wave signals; processing the at least one millimeter wave signal received by the at least one receiving antenna; determining from the processing of the at least one millimeter wave signal that an object or body part has interacted with the at least one millimeter wave signal; and transmitting another millimeter wave signal that is different than the at least one millimeter wave signal from at least one at least one of the plurality of transmitting antennas, wherein the other millimeter wave signal provides better resolution of the object or body part than the at least one millimeter wave signal when processed.

While the invention has been particularly shown and described with reference to a preferred embodiment thereof, it will be understood by those skilled in the art that various changes in form and details may be made therein without departing from the spirit and scope of the invention.

1. A millimeter wave sensor array, comprising:
a signal generator adapted to generate a plurality of millimeter wave signals;
at least one transmitting antenna operably connected to the signal generator and adapted to transmit at least one millimeter wave signal from the plurality of millimeter wave signals;
at least one receiving antenna adapted to receive millimeter wave signals; and
a signal processor adapted to process received millimeter wave signals, wherein when a processed millimeter wave signal indicates an object or body part has interacted with the at least one millimeter wave signal, another millimeter wave signal is transmitted that is different than the at least one millimeter wave signal, wherein the another millimeter wave signal is adapted to provide better resolution of the object or body part than the at least one millimeter wave signal when processed.

2. The millimeter wave sensor array of claim 1, wherein the at least one transmitting antenna is one of a plurality of transmitting antennas.

3. The millimeter wave sensor array of claim 1, wherein the at least one receiving antenna is one of a plurality of receiving antennas.

4. The millimeter wave sensor array of claim 1, wherein the another millimeter wave signal is transmitted from a different transmitting antenna than the at least one transmitting antenna.

5. The millimeter wave sensor array of claim 1, wherein the at least one transmitting antenna is adapted to receive at least one of the plurality of millimeter wave signals.

6. The millimeter wave sensor array of claim 1, wherein the at least one receiving antenna is adapted to transmit at least one of the plurality of millimeter wave signals.

7. The millimeter wave sensor array of claim 1, wherein when the signal processor processes the another millimeter wave signal and determines that the object or body part is approaching the millimeter wave sensor array, still another millimeter wave signal is transmitted that is different than the another millimeter wave signal and the at least one millimeter wave signal, wherein the still yet another millimeter wave signal provides better resolution of the object or person than the at least one millimeter wave signal and the another millimeter wave signal.

8. The millimeter wave sensor array of claim 1, wherein the frequency of the first millimeter wave signal is between 5 Ghz and 70 Ghz.

9. The millimeter wave sensor array of claim 1, wherein processed millimeter wave signals determine gestures of a hand.

10. The millimeter wave sensor array of claim 1, wherein processed millimeter wave signals provide mapping of an area.

11. A method of improving resolution of a millimeter wave sensor array, the method comprising:
generating a plurality of millimeter wave signals with a signal generator;
transmitting the plurality of millimeter wave signals from at least one of a plurality of transmitting antennas operably connected to the signal generator;
receiving at least one millimeter wave signal from the plurality of millimeter wave signals at at least one receiving antenna operably connected to a signal processor and adapted to receive the plurality of millimeter wave signals;
processing the at least one millimeter wave signal received by the at least one receiving antenna;
determining from the processing of the at least one millimeter wave signal that an object or body part has interacted with the at least one millimeter wave signal; and
transmitting another millimeter wave signal that is different than the at least one millimeter wave signal from at least one at least one of the plurality of transmitting antennas, wherein the other millimeter wave signal provides better resolution of the object or body part than the at least one millimeter wave signal when processed.

12. The method of claim 11, wherein the at least one receiving antenna is one of a plurality of receiving antennas.

13. The method of claim 11, wherein the other millimeter wave signal is transmitted from a different transmitting antenna than the at least one millimeter wave signal.

14. The method of claim 11, wherein the at least one of a plurality of transmitting antennas is adapted to receive the at least one the plurality of millimeter wave signals.

15. The method of claim 11, wherein the at least one receiving antenna is adapted to transmit at least one of the plurality of millimeter wave signals.

16. The method of claim 11, wherein the frequency of the at least one millimeter wave signal is between 5 Ghz and 70 Ghz.

17. The method of claim 11, further comprising determining gestures of a hand using processed millimeter wave signals.

18. The method of claim 11, further comprising processing millimeter wave signals to provide mapping of an area.

19. The method of claim 11, wherein the difference between the at least one millimeter wave signal and the other millimeter wave signal is the phase.

20. The method of claim 11, wherein the difference between the at least one millimeter wave signal and the other millimeter wave signal is the frequency.
